(19) United States
(12) Patent Application Publication
(10) Pub. No.: US 2024/0199943 A1
(43) Pub. Date: Jun. 20, 2024

(54) CRUDE OIL PRODUCTION USING A COMBINATION OF EMULSION VISCOSITY REDUCER AND SCALE INHIBITOR

(71) Applicant: ChampionX USA Inc., Sugar Land, TX (US)

(72) Inventors: Brian Scott Caird, Sugar Land, TX (US); Marcin Kopowicz, Sugar Land, TX (US); Michael Francis Johnston, Sugar Land, TX (US)

(21) Appl. No.: 18/554,494

(22) PCT Filed: Apr. 8, 2022
(86) PCT No.: PCT/US2022/023984

§ 371 Date: Oct. 9, 2023

(30) Foreign Application Priority Data
Apr. 9, 2021 (GB) 2105118.0

(51) Int. Cl. C09K 8/588; C09K 8/52

(52) U.S. Cl. CPC C09K 8/588; C09K 8/52

(57) ABSTRACT

The present invention pertains to a composition for crude oil production, comprising an emulsion viscosity reducer (EVR); a scale inhibitor, and a solvent system comprising water, an oil soluble solvent and a co-solvent; to a process for production of crude oil using the compositions; and the use of the compositions as flow improver or viscosity reducer.

### FIELD OF THE INVENTION

The present application provides a stable compositions comprising an emulsion viscosity reducer and a scale inhibitor in a solvent system, a process for production of crude oil using this composition and the use of the compositions as flow improver or viscosity reducer.

### BACKGROUND OF THE INVENTION

Global heavy oil accounts for over 70% of total remaining oil resources. Due to the high content of colloid and asphaltene, heavy oil has the characteristics of high density, high viscosity and poor fluidity, which results in difficult exploitation and transportation.

One of the most expensive steps in crude oil production is lifting of fluids from the well to the surface for processing. The fluid comprises brine, gas and crude oil and encounters high shears and pressure drops whilst flowing through the production lines and pumps. In addition, crude oil typically contains naturally occurring materials which act as emulsifiers. When subjected to shear as mentioned above, the fluids may form emulsions carrying a viscosity that can be many times higher than the crude oil itself. This increase in viscosity is the main reason for higher costs associated with production of crude oil.

In order to counter this increase in viscosity during lifting of the fluids to the surface for processing emulsion viscosity reducers (EVR) are added to the fluids. EVR are chemical compounds designed to interact with the natural emulsifiers at the water-oil interface and to facilitate water-oil separation. Collapse of the emulsion leads to an increased flow and production. EVR are generally added to the fluids either via a chemical injection line into the well or into the gas lift. Typically, the number of possible lines for injection are limited.

Further adjuvants such as scale inhibitors are often required as well to optimise the flow and the conditions of the fluid lines. Scale formation leads to blocking or hindering fluid flow through pipelines, valves and pumps in oil production and processing. Scale inhibitors are several classes of chemicals that prevent accumulation of solid deposits and which can be tailored to address different chemical qualities of scales such as calcium carbonate (limescale), iron sulphides, barium sulfate and strontium sulfate.

However, scale inhibitors are normally not compatible with EVRs in a single composition. Often there is only a single chemical injection line available such that conditions dictate whether EVR or scale inhibitor is needed mostly. As conditions might change quickly, during the time of change from one to the another production might be negatively affected.

The object of the present application has therefore been to provide a composition and a method for dosing EVR in combination with a scale inhibitor in a single composition.

### BRIEF SUMMARY OF THE INVENTION

In a first aspect, there is provided a composition for crude oil production, comprising an emulsion viscosity reducer (EVR); a scale inhibitor (SI); and a solvent system which comprises water, an oil soluble solvent and a co-solvent.

In one embodiment the oil soluble solvent is selected from aromatic solvents, alkyl alcohols having 6 or more carbon atoms; glycols, glycol esters, glycol ethers comprising more than 6 carbon atoms; and any mixture thereof.

The aromatic solvent may have a boiling point in the range from 135° C. to 290° C.

In embodiments, the oil soluble solvent is selected from ethylene glycol monobutyl ether, diethylene glycol monoethylether, dipropyleneglycol methyl ether, ethylene glycol diethyl ether, ethylene glycol monoethyl ether acetate, propylene glycol methyl ether acetate, and any mixtures thereof.

In embodiments, the co-solvent is selected from alkyl alcohols comprising 1 to 3 hydroxyl groups and less than 6 carbon atoms and any mixture thereof.

Preferably the co-solvent is selected from methanol, ethanol, propanol, isopropanol, butanol, 1,2-propylene glycol, 1,3-propylene glycol, 1,4-butanediol, 1,5-pentanediol, monoethylene glycol, diethylene glycol, glycerol and any mixture thereof.

In embodiments, the composition comprises 60 to 94.6 wt. % of the solvent system, preferably 75 to 92.5 wt. % and more preferably 82 to 89 wt. %.

The composition may comprise 5 to 30 wt. % of emulsion viscosity reducer, preferably 7 to 20 wt. %. and most preferably 10 to 15 wt. % of viscosity reducer.

The composition may comprise 0.1 to 10 wt. % of scale inhibitor, preferably 0.5 to 5 wt. % and more preferably 1 to 3 wt. % of scale inhibitor.

In one embodiment the composition further comprises a surfactant. The composition may comprise the surfactant in an amount of 0.1 to 10 wt. %, preferably in an amount of 0.5 to 5 wt. % and more preferably 1 to 3 wt. %.

The surfactant may have an HLB value between 3 and 9. The surfactant is preferably an anionic surfactant.

In embodiments the surfactant is selected from dodecyl benzene sulfonic acid (DDBSA), 2-ethylhexanol phosphate ester, pivalic acid, neodecanoic acid, oxalic acid or mixtures thereof.

In embodiments, the composition comprises the surfactant in an amount of 0.1 to 10 wt. %, preferably in an amount of 0.5 to 5 wt. % and more preferably 1 to 3 wt. %.

In a second aspect, a process is provided for production of crude oil comprising injecting a composition described in the present application into a well, and lifting the resulting fluid to the surface for processing.

The fluid may comprise crude oil, gas and brine.

The composition may be injected into the well via a chemical injection line.

Alternatively, the composition may be injected into the gas lift.

In a third aspect, a composition in accordance with the present application is used as flow improver or viscosity reducer.

### BRIEF DESCRIPTION OF THE DRAWINGS

FIG. 1 shows the pressure differential as a function of time during the Dynamic Scale Loop Test for scale inhibitor A at different concentrations.

FIG. 2 shows the pressure differential as a function of time during the Dynamic Scale Loop Test for an embodiment of the present invention.

FIG. 3 depicts the pressure differential as a function of time during the Dynamic Scale Loop Test for scale inhibitor A at higher concentrations and longer test times.

FIG. 4 depicts the pressure differential as a function of time during the Dynamic Scale Loop Test for scale inhibitor A at higher concentrations and longer test times.

FIG. 5 shows the viscosity of mixtures of crude oil and brine compositions at different mixing ratio.

### DETAILED DESCRIPTION OF THE INVENTION

The present invention provides a composition for crude oil production that delivers emulsion viscosity reducers (EVR) and scale inhibitors (SI) in a single composition. This composition is then injected into the well using only one injection line improving the flow of the crude oil.

### Emulsion Viscosity Reducer

Emulsion viscosity reducers (EVR) are chemical compounds or compositions which reduce the overall viscosity of the fluid. EVR are designed to interact with the natural emulsifiers comprised in crude oil. These natural emulsifiers are responsible for creating emulsions when crude oil is mixed with brine. EVR react with the natural emulsifiers at the water-oil interface and facilitate water and oil separation thus breaking the emulsion. Whilst the emulsified fluid typically has a much higher viscosity, addition of EVR results in a lowering of the overall viscosity of the fluid and thus an increased flow and production.

The EVR is based on a compound a starting material selected from an alcohol, an amine, and imine, an alkyl phenol aldehyde resin or any mixture thereof. This compound or mixture of compounds is then alkoxylated and further reacted as described below.

Before alkoxylation or further reaction, the alcohol may comprise 1 to 6 hydroxy groups and 1 to 50 carbon atoms; the amine may comprise 1 to 6 amine functional groups and 1 to 50 carbon atoms; the imine may comprise 1 to 10 imine functional groups and 1 to 50 carbon atoms. The alkoxylated alkyl phenol formaldehyde resin may have the following formula 1,

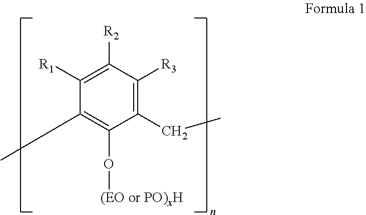

Wherein R₁ to R₃ are alkyl groups having 1 to 12 carbon atoms, x is a number of 1 to 200, and n is a number from 1 to 50.

Alkoxylation of the starting material is selected from ethoxylation and/or propoxylation. The reacted product may comprise after alkoxylation 1 to 200 moles of ethoxy units per mole of starting material. The reacted product may comprise after alkoxylation 1 to 200 moles of propoxy units per mole of starting material. The reacted product may comprise after alkoxylation 1 to 200 moles of ethoxy units per mole of the starting material. The reacted product may comprise after alkoxylation 1 to 200 moles of propoxy and ethoxy units per mole of starting material.

The alkoxylated compounds are then crosslinked by reaction with bifunctional compounds. Typical examples for suitable bifunctional compounds are:
toluene diisocyanate (TDI); or
Bisphenol A diglycidyl ether (BADGE); or
a mixture of maleic anhydride and acrylic acid.

Examples for suitable emulsion viscosity reducers are trimethyl propanol alkoxylate and phenol, 4,4′-!1-methylethylidene)bis-, polymer with (chloromethyl)oxirane.

### Scale Inhibitor

Scale inhibitors are specialty chemicals that are added to the fluid in oil production systems to delay, reduce and/or prevent scale formation in productions lines and pumps. Different scale inhibitors are designed for specific scaling conditions. Ions in the aqueous phase of the fluid which could be responsible for the precipitation of scales are bound by the scale inhibitor molecules. Typically, in order to bind positively charged ions scale inhibitors comprise phosphonate, phosphate, phosphinate, sulfonate and/or carboxylate groups.

Suitable scale inhibitors include, but are not limited to, phosphates, phosphate esters, phosphoric acids, phosphonates, phosphonic acids, polyacrylamides, salts of acrylamido-methyl propane sulfonate/acrylic acid copolymer (AMPS/AA), phosphinated maleic copolymer (PHOS/MA), salts of a polymaleic acid/acrylic acid/acrylamido-methyl propane sulfonate terpolymer (PMA/AMPS), and any combination thereof.

Examples of particularly suitable scale inhibitors are sodium polyaspartate and 2-butenedioic acid (2Z)—, polymer with sodium 2-propene-1-sulfonate (1:1).

### Solvent System

The emulsion viscosity reducer and the scale inhibitor are solubilized in a solvent system. The solvent system comprises water, an oil soluble solvent and a co-solvent.

Suitable oil soluble solvents include but are not limited to aromatic solvents; alkyl alcohols having 6 or more carbon atoms in the alkyl chain; glycols, glycol esters and glycol ethers comprising more than 6 carbon atoms; and any mixtures thereof.

Non-limiting examples of suitable oil soluble solvents are ethylene glycol monobutyl ether, diethylene glycol monoethylether, dipropyleneglycol methyl ether, ethylene glycol diethyl ether, ethylene glycol monoethyl ether acetate, propylene glycol methyl ether acetate, and any mixtures thereof.

The aromatic solvents may have a boiling point in the range from 135° C. to 290° C. The aromatic solvent may have a boiling point in the range from 135° C. to 210° C. The aromatic solvent may have a boiling point in the range from 165° C. to 290° C. The aromatic solvent may comprise 8 to 16 carbon atoms. The aromatic solvent may comprise 8 to 10 carbon atoms or 9 to 16 carbon atoms. The aromatic solvent may comprise naphtha.

Suitable co-solvents are alkyl alcohols comprising less than 6 carbon atoms and 1 to 3 hydroxy groups and include, but are not limited to methanol, ethanol, propanol, isopropanol, butanol, 1,2-propylene glycol, 1,3-propylene glycol, 1,4-butanediol, 1,5-pentanediol, monoethylene glycol, diethylene glycol, glycerol and any mixture thereof.

In embodiments the composition comprises the solvent system in an amount of 60 to 94.6 wt. %, preferably 75 to 92.5 wt. % and more preferably 82 to 89 wt. %.

### Surfactant

In one embodiment the composition further comprises a surfactant. The surfactant stabilizes the composition and further helps to reduce the emulsion viscosity. The surfactant may have an HLB value between 3 and 9. The surfactant is preferably an anionic surfactant.

Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates, and combinations thereof.

In embodiments the surfactant is selected from dodecyl benzene sulfonic acid (DDBSA), 2-ethylhexanol phosphate ester, pivalic acid, neodecanoic acid, oxalic acid or mixtures thereof.

The composition may comprise the surfactant in an amount of 0.1 to 10 wt. %, preferably in an amount of 0.5 to 5 wt. % and more preferably 1 to 3 wt. %.

### Further Adjuvants

Further adjuvants which may be included in the compositions include, but are not limited to corrosion inhibitors, hydrogen sulphide scavengers, pour point depressants, asphaltene inhibitors, paraffin inhibitors, gas hydrate inhibitors, pH modifiers or any combination thereof.

### Fluid

Fluid in the sense of the present application refers to the mixture of crude oil, brine and optionally gas that is lifted from the well to the surface for processing.

Various further aspects and embodiments of the present invention will be apparent to those skilled in the art in view of the present disclosure.

As used herein, the proportions defined as percentages by total weight of the composition are weight by total dry weight of the composition.

Other aspects and embodiments of the invention provide the aspects and embodiments described above with the term “comprising” replaced by the term “consisting of” and the aspects and embodiments described above with the term “comprising” replaced by the term “consisting essentially of”.

It is to be understood that the application discloses all combinations of any of the above aspects and embodiments described above with each other, unless the context demands otherwise. Similarly, the application discloses all combinations of the preferred and/or optional features either singly or together with any of the other aspects, unless the context demands otherwise.

Modifications of the above embodiments, further embodiments and modifications thereof will be apparent to the skilled person on reading this disclosure, and as such these are within the scope of the present invention.

All documents mentioned in this specification are incorporated herein by reference in their entirety for all purposes.

The term “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Certain aspects and embodiments of the invention will now be illustrated by way of example and with reference to the figures described above and the following tables.

### EXAMPLES

The following compositions were prepared by mixing the ingredients in the given amounts.

### Example 1: Composition A for Crude Oil Production

TABLE 1

| Composition A | Wt. % actives |
|---|---|
| Ethylene glycol monobutyl ether | 17.0 |
| Monoethylene glycol | 41.5 |
| Deionized water | 29.5 |
| Emulsion Viscosity Reducer A | 10.1 |
| Scale Inhibitor A | 1.4 |
| Potassium hydroxide (49%) | 0.5 |

### Example 2: Composition B for Crude Oil Production

TABLE 2

| Composition B | Wt. % actives |
|---|---|
| Ethylene glycol monobutyl ether | 36.2 |
| Monoethylene glycol | 40.4 |
| Deionized water | 8.0 |
| Emulsion Viscosity Reducer A | 12.7 |
| Emulsion Viscosity Reducer B | 0.63 |
| Scale Inhibitor B | 2.0 |
| Heavy aromatic naphtha | 0.07 |

Emulsion Viscosity Reducer A is trimethyl propanol alkoxylate.

Emulsion Viscosity Reducer B is phenol, 4,4′-(1-methylethylidene)bis-, polymer with (chloromethyl)oxirane, methyloxirane and oxirane.

Scale Inhibitor A is 2-butenedioic acid (2Z)—, polymer with sodium 2-propene-1-sulfonate (1:1)—CAS number 68715-83-3.

Scale Inhibitor B is sodium polyaspartate—CAS number 94525-01-6.

### Example 3: Scale Inhibitor Performance Testing

In order to determine the viscosity reducing and scale inhibiting properties of the compositions of Examples 1 and 2 under downhole conditions, the following tests were conducted.

Typically, the method used to measure scale inhibition is referred to as the ‘Dynamic Scale Loop’ test. This is a method whereby a fluid composition comprising specific cations and anions is injected via separate injection pumps to a narrow bore stainless steel coil which is housed within an oven heated to the desired temperature. The pressure is measured across the coil and an increase in differential pressure indicates the formation of scale, such as calcium carbonate and barium sulfates. The successful inhibition of scale is typically deemed to be the minimum concentration of scale inhibitor required to prevent an increase of more than 1.5 psi (10.3 kPa) for 2.5 times the required time for scaling to occur without the addition of a scale inhibitor.

In the example discussed below, brines of the composition shown in Table 3 formed scale resulting in an increase of 1.5 psi (10.3 kPa) after 20 minutes. In accordance with the Dynamic Scale Loop test successful inhibition is deemed to be the concentration of scale inhibitors required to prevent an 1.5 psi (10.3 kPa) increase within 50 minutes.

The brine composition shown in Table 3 represents a typical chemistry as found in oil fields in the North Sea.

TABLE 3
brine composition

| | Concentration |
|---|---|
| Ion | mg/L |
| Na | 22492 |
| Ca | 2578 |
| Mg | 538 |
| K | 512 |
| Ba | 209 |
| Sr | 377 |
| Fe | 0 |
| SO₄ | 9 |
| HCO₃ | 878 |
| Cl | 40820 |

For the preparation of the brine composition of Table 3, aqueous compositions of the respective anions (such as sodium salts) and the respective cations are prepared separately and the scale inhibitor is dosed in the anionic brine at the appropriate concentration.

The test conditions are as detailed below in Table 4.

TABLE 4
Test conditions for the Dynamic Scale Loop Test

| Coil dimensions | 1 m × 1 mm stainless steel | |
|---|---|---|
| Temperature | 80° | C. |
| Flow rate | 10 | ml/minute |

| | |
|---|---|
| Brine pH | 7.2 |
| Pressure | 200 psi (1379 kPa) |

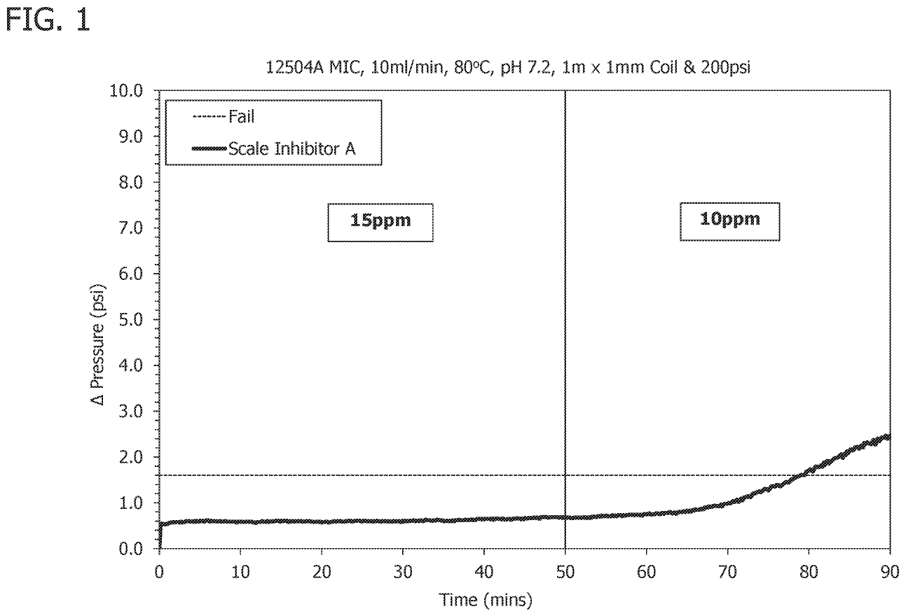

The results for Scale Inhibitor A are shown in FIG. 1. Scale inhibitor A is 2-butenedioic acid (2Z)—, polymer with sodium 2-propene-1-sulfonate (1:1)—CAS number 68715-83-3.

For the Dynamic Scale Loop Test shown in FIG. 1 a composition comprising 16.8 wt. % of scale inhibitor A is used which comprises the same solvent system as used in Composition A of Example 1. A minimum of 15 ppm of this composition is required to prevent scale formation within 50 minutes under the test conditions equaling to 2.5 ppm of scale inhibitor A. If the concentration of the Scale inhibitor is reduced to 10 ppm of the composition (corresponding to 1.7 ppm active substance of scale inhibitor A) fail occurs already after about 30 minutes.

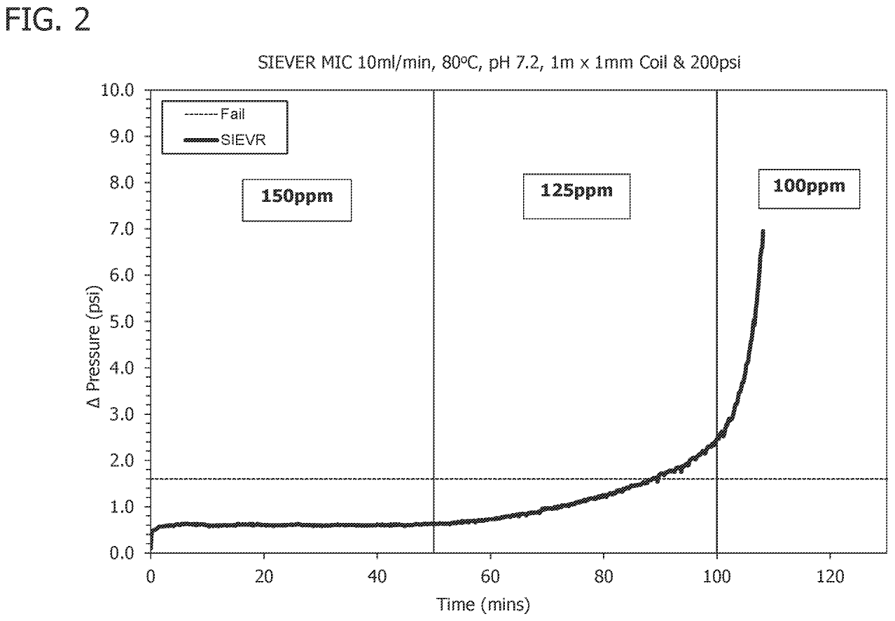

FIG. 2 shows the results under the same conditions for Composition A of Example 1 comprising both scale Inhibitor A and emulsion viscosity reducer A (trimethyl propanol alkoxylate) titled SIEVR.

Composition A comprises 1.4 wt. % of scale inhibitor A and a minimum of 150 ppm of composition A is required to prevent scale formation within 50 minutes under the test conditions. This corresponds to an active matter content for scale inhibitor A of around 2.1 ppm.

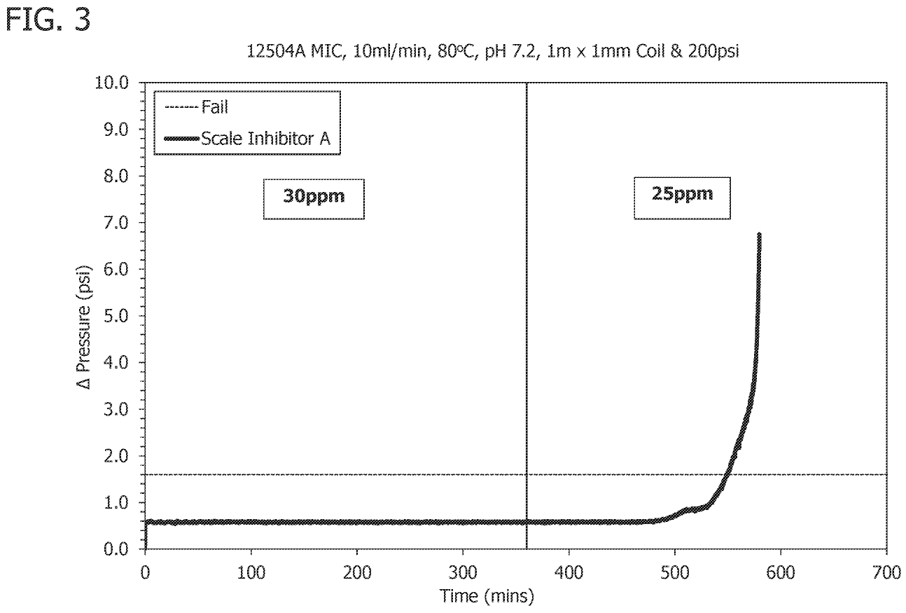

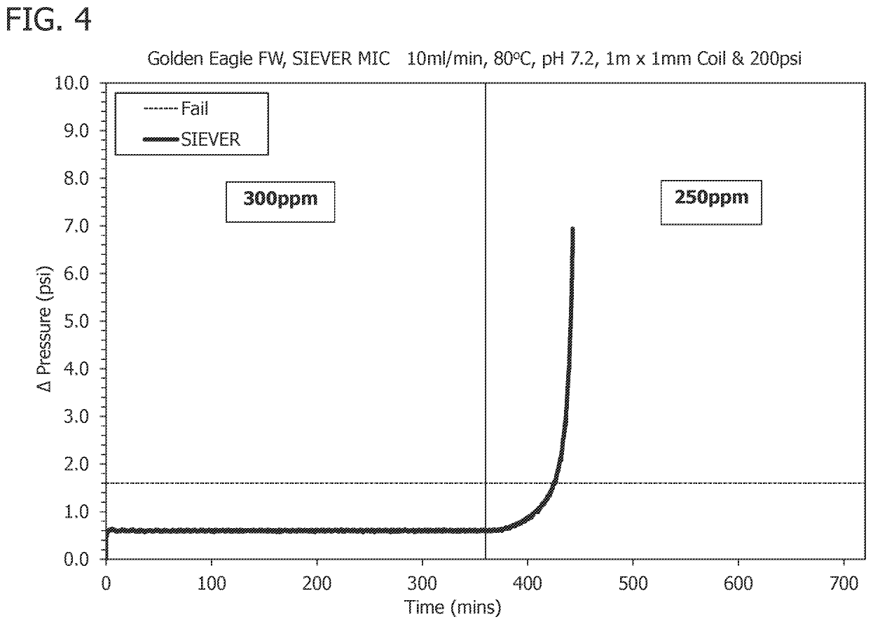

Further tests were performed with higher concentrations of scale inhibitor A over a period of 6 hours to determine minimum scale inhibitor concentration to prevent an increase in differential pressure of more than 1.5 psi (10.3 kPa) as shown in FIGS. 3 and 4.

In FIG. 3, a composition comprising scale Inhibitor A at a concentration of 16.8 wt. % of the composition required a minimum of 30 ppm (corresponding to 5 ppm active matter of scale inhibitor A) of the composition to prevent scale formation within 360 minutes under the respective test conditions shown in Table 4. When the concentration of the composition was reduced 25 ppm of the composition (corresponding to 4.2 ppm of scale inhibitor A) differential pressure rose to above 1.5 psi (10.3 kPa) already after about 140 minutes.

Test results of composition A of Example 1 are shown in FIG. 4 (SIEVR). A minimum of 300 ppm of the composition (corresponding to 4.2 ppm of scale inhibitor A) were required to prevent scale formation within 360 minutes under the Dynamic Scale Loop test conditions. Reduction of the active content of scale inhibitor A to 3.5 ppm (corresponding to 250 ppm of composition A) failed within about 50 mins.

These examples demonstrate that the scale inhibitor is still effective when combined in a composition with an emulsion viscosity reducer and solvent system.

### Example 4: Emulsion Viscosity Reducer Performance Testing

In order to compare the performance of a composition comprising both the emulsion viscosity reducer and the scale inhibitor a viscosity cup was used to measure the effectiveness of reduction of fluid viscosity. A viscosity cup is a vessel comprising a heated jacket that typically holds a volume of 100 ml of fluid and that has an orifice at the bottom of the cup of known diameter through which the fluid can flow out of the cup. The time taken by the fluids to flow from the cup is proportional to the viscosity of the fluids. A reduction in time for the cup to empty for a fluid comprising an emulsion viscosity reducer corresponds to the effectiveness of the added emulsion viscosity reducer. Typically, a 4 mm diameter orifice is used while other diameters, such as 2 mm, can also be suitable depending on the viscosity of the fluids.

To test the compositions of the present application a crude oil emulsion was prepared combining a 31 API gravity North Sea crude oil and the brine composition of Table 3. The resulting fluid is heated to a temperature of 80° C. and mixed using an Ultra Turrix high shear mixer at a speed of 15,000 rpm for a period of 4 minutes.

The crude oil and brine composition were combined at weight ratios of 30:70, 50:50 and 70:30 of crude oil/brine composition. Upon mixing the flow time through the viscosity cup was measured using a 2 mm diameter orifice. The flow time of the neat crude oil and neat brine composition were also measured.

In addition to the two neat samples and the three different crude oil/brine compositions, the viscosity was also determined samples with each of the above ratios of crude oil/brine composition comprising in addition either 300 ppm of composition A of Example 1 or 28.65 ppm of emulsion viscosity reducer A. Emulsion viscosity reducer A was also used in composition A of Example 1.

Composition A of Example 1 contains 10.1 wt. % actives of emulsion viscosity reducer A, which is equivalent to 30.3 ppm of emulsion viscosity reducer.

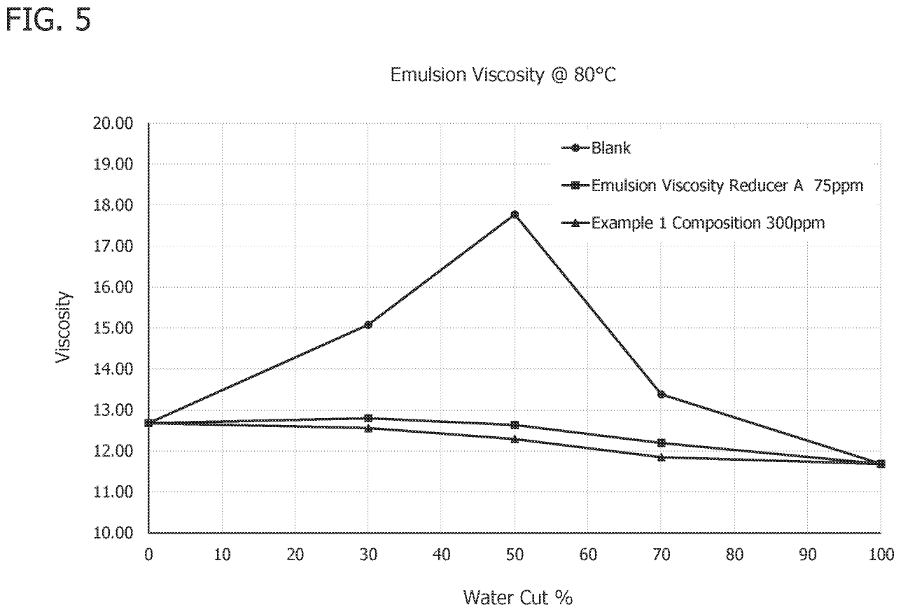

FIG. 5 plots the viscosity in cSt against the weight percentage of the brine composition for the compositions not comprising any emulsion viscosity reducers and for the six different compositions comprising the emulsion viscosity reducers.

Without any emulsion viscosity reducers present, the viscosity goes up to almost 18 cSt for the mixture of weight ratio 50:50 of crude oil/brine composition whereas this is reduced to around 12 cSt as soon as an emulsion viscosity reducer is present. This effect is also present for the mixtures of weight ratios 70:30 and 30:70 of crude oil/brine composition.

Examples 3 and 4 demonstrate that the compositions of the compositions for crude oil production of the present application are effective to improve the flow of crude oil. Neither the emulsion viscosity reducers nor the scale inhibitors lose their efficiency in these formulations which employs the solvent system that is capable of solubilising both the emulsion viscosity reducers and the scale inhibitors.

1. A composition for crude oil production, comprising
a) an emulsion viscosity reducer;
b) a scale inhibitor; and
c) a solvent system; which comprises
i) water,
ii) an oil soluble solvent, and
iii) a co-solvent.

2. Composition according to claim 1, wherein the oil soluble solvent is selected from aromatic solvents, alkyl alcohols having 6 or more carbon atoms; glycols, glycol esters, glycol ethers comprising more than 6 carbon atoms; and any mixture thereof.

3. Composition according to claim 2, wherein the aromatic solvent has a boiling point in the range from 135° C. to 290° C.

4. Composition according to any one of claims 1 to 3, wherein the oil soluble solvent is selected from ethylene glycol monobutyl ether, diethylene glycol monoethylether, dipropyleneglycol methyl ether, ethylene glycol diethyl ether, ethylene glycol monoethyl ether acetate, propylene glycol methyl ether acetate, and any mixtures thereof.

5. Composition according to any one of claims 1 to 4, wherein the co-solvent is selected from alkyl alcohols comprising 1 to 3 hydroxyl groups and less than 6 carbon atoms and any mixture thereof.

6. Composition according to claim 5, wherein the co-solvent is selected from methanol, ethanol, propanol, isopropanol, butanol, 1,2-propylene glycol, 1,3-propylene glycol, 1,4-butanediol, 1,5-pentanediol, monoethylene glycol, diethylene glycol, glycerol and any mixture thereof.

7. Composition according to any one of claims 1 to 6, wherein the composition comprises 60 to 94.6 wt. % of the solvent system.

8. Composition according to any one of claims 1 to 7, wherein the composition comprises 0.1 to 10 wt. % of scale inhibitor.

9. Composition according to any one of claims 1 to 8, wherein the composition comprises 1 to 20 wt. % of emulsion viscosity reducer.

10. Composition according to any one of claims 1 to 9, wherein the composition further comprises a surfactant.

11. Composition according to claim 10, wherein the composition comprises the surfactant in an amount of 0.1 to 10 wt. %.

12. Composition according to any one of claims 10 and 11, wherein the surfactant is an anionic surfactant.

13. Composition according to any one of claims 10 to 12, wherein the surfactant is selected from dodecyl benzene sulfonic acid (DDBSA), 2-ethylhexanol phosphate ester, pivalic acid, neodecanoic acid, oxalic acid or mixtures thereof.

14. A process for production of crude oil comprising
injecting a composition according to any one of claims 1 to 13 into the well, and
lifting the resulting fluid to the surface for processing.

15. Process according to claim 14, wherein the fluid comprises crude oil, gas and brine.

16. Process according to any one of claims 14 and 15, wherein the composition is injected into the well via a chemical injection line.

17. Process according to anyone of claims 14 to 16, wherein the composition is injected into the gas lift.

18. Use of a composition according to any one of claims 1 to 13 as a flow improver.

19. Use of a composition according to any one of claims 1 to 13 as a viscosity reducer.
